(19) United States
(12) Patent Application Publication
(10) Pub. No.: US 2013/0305165 A1
(43) Pub. Date: Nov. 14, 2013

(54) System and method for folder conduits

(71) Applicant: Thomas Zuber, Los Angeles, CA (US)

(72) Inventor: Thomas Zuber, Los Angeles, CA (US)

(21) Appl. No.: 13/892,183

(22) Filed: May 10, 2013

Related U.S. Application Data
(60) Provisional application No. 61/688,335, filed on May 10, 2012.

(51) Int. Cl. H04L 12/58

(52) U.S. Cl. CPC H04L 51/00
USPC 715/752

(57) ABSTRACT

The invention provides a digital document management system that incorporates email functionality. The system allows an individual user to share documents and emails with others via a folder conduit system.

### CROSS-REFERENCE TO RELATED APPLICATIONS

This application claims the benefit of U.S. Provisional Application Ser. No. 61/688,335 filed May 10, 2012, which is hereby incorporated by reference in its entirety.

This application is related to commonly-owned U.S. Application Ser. No. 61/210,627, filed Mar. 20, 2009, U.S. application Ser. No. 12/493,096, filed Jun. 26, 2009, U.S. application Ser. No. 12/575,442, filed Oct. 7, 2009, U.S. application Ser. No. 12/885,325, filed Sep. 17, 2010, U.S. application Ser. No. 13/011,655, filed Jan. 21, 2011, U.S. application Ser. No. 13/023,461, filed Feb. 8, 2011, U.S. application Ser. No. 13/247,813, filed Sep. 28, 2011, U.S. application Ser. No. 13/278,127, filed Oct. 20, 2011, U.S. application Ser. No. 13/324,980, filed Dec. 13, 2011, U.S. application Ser. No. 13/645,234, filed Oct. 4, 2012, and U.S. application Ser. No. 13/849,418, filed Mar. 22, 2013. The contents of each of these patent applications are incorporated herein in their entirety by reference., each of which is incorporated by reference herein in its entirety.

### FIELD OF THE INVENTION

The invention relates to the field of cloud-based collaboration.

### BACKGROUND

Electronic document management systems known in the art are typically limited by conventional modes of organizational access. What is needed and provided by the present invention are electronic document managements systems and related methods that embody and facilitate social collaboration features.

### SUMMARY OF THE INVENTION

A method for interactively collaborating within an online community, comprising a plurality of members, a network of members that excludes at least one member of the community, whereby members of the network share access to financial information in a secured remote environment, such that members not belonging to the network do not have access to the financial information, a financial management tool comprised of a billing application and an invoicing application, whereby the financial management tool enables the members of the network to remotely manage the financial information; a matters tool for assigning a folder set to a matter, whereby a member of the network can cause the folder set to appear in the user's document management room, whereby the folder set also appears in the user's local email application; and a folder conduit associated with the folder set, whereby a member of the network can drag and drop an email over the folder conduit and thereby cause the email to appear in pre-designated folder of the folder set in the user's email application, whereby the email also appears in the folder set in the user's document management room

Additional features, advantages, and embodiments of the invention may be set forth or apparent from consideration of the following detailed description, drawings, and claims. Moreover, it is to be understood that both the foregoing summary of the invention and the following detailed description are exemplary and intended to provide further explanation without limiting the scope of the invention as claimed.

### BRIEF DESCRIPTION OF THE DRAWINGS

FIG. 1 shows the Secure Organization Loop (SOL) profile for an embodiment of the invention.

FIG. 2 shows the Edit Loop Members Page for an embodiment of the invention.

FIG. 3 shows the View Loop Profile Page for an embodiment of the invention.

FIG. 4 shows an unexpanded page view of a Document Management Room (DMR) for an embodiment of the invention.

FIG. 5 shows an expanded page view of a Document Management Room (DMR) for an embodiment of the invention.

FIG. 6 shows the folder conduit process and architecture for an embodiment of the invention.

FIG. 7 shows the integration of the DMR and the local email application for an embodiment of the invention.

FIG. 8 shows an expanded page view of a DMR for an embodiment of the invention.

FIG. 9 shows the integration of the DMR and a cloud-based email application for an embodiment of the invention.

### DETAILED DESCRIPTION

Herein is described a digital document management system, referred to as the Document Management Room (hereinafter referred to as “DMR”) that has email functionality. In DMR, users can view, edit, delete, save and retrieve documents (including, for example, word processing documents, spreadsheets, power point presentations, emails, pdf and tiff files, and other images), and view, access and alter the contents of folders. The DMR allows an individual user to share documents and emails with others via a Folder Conduit system. The preferred embodiment of the Folder Conduit feature allows for the ability to access and share email content in LawLoop.com's DMR directly via proprietary desktop email application software, like for instance Microsoft Outlook, which is stored locally, either on a user's hard drive or hosted on a private server, and run on a user's desktop or laptop (hereinafter referred to as “local email application”). The alternative embodiment of the Folder Conduit feature likewise allows for the ability to access and share email content in LawLoop.com's DMR, this time via a cloud computing based email application (hereinafter referred to as the “cloud based email application”), such as Gmail or Hotmail, which are not stored locally on a user's desktop or laptop.

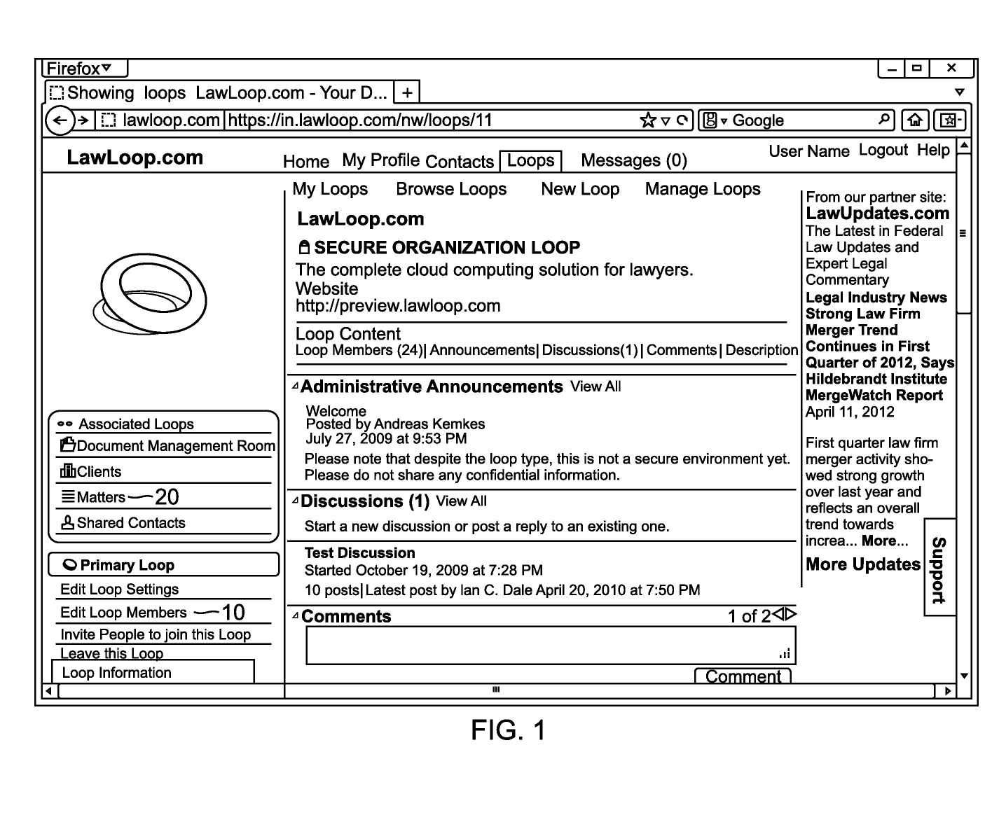

Once an individual or organizational entity opens an account on LawLoop.com and establishes their profile, they can create a group of members called a Secure Organization Loop (hereinafter referred to as “SOL”). A SOL is a network that contains a unique set of members, settings and features as determined by the SOLs creator and or an administrator(s). The user is free to create and belong to multiple SOLs with a valid LawLoop.com account. When a SOL is created the SOL's creator may invite contacts to become members, thereby granting access to that specific SOL. Members of the SOL share secure access to remotely stored documents and financial information, and to document management applications (for example, word processing, spreadsheet, power point, email image viewing, and document storage applications) and financial management applications (for example, time-tracking/billing applications, accounting applications, and invoicing applications). The user may also wish to edit the membership of an existing SOL. In order to add new members to a SOL or to edit existing members of a SOL the user must Edit Loop Members (as shown at 10 in FIG. 1).

### Invite and Edit Loop Members

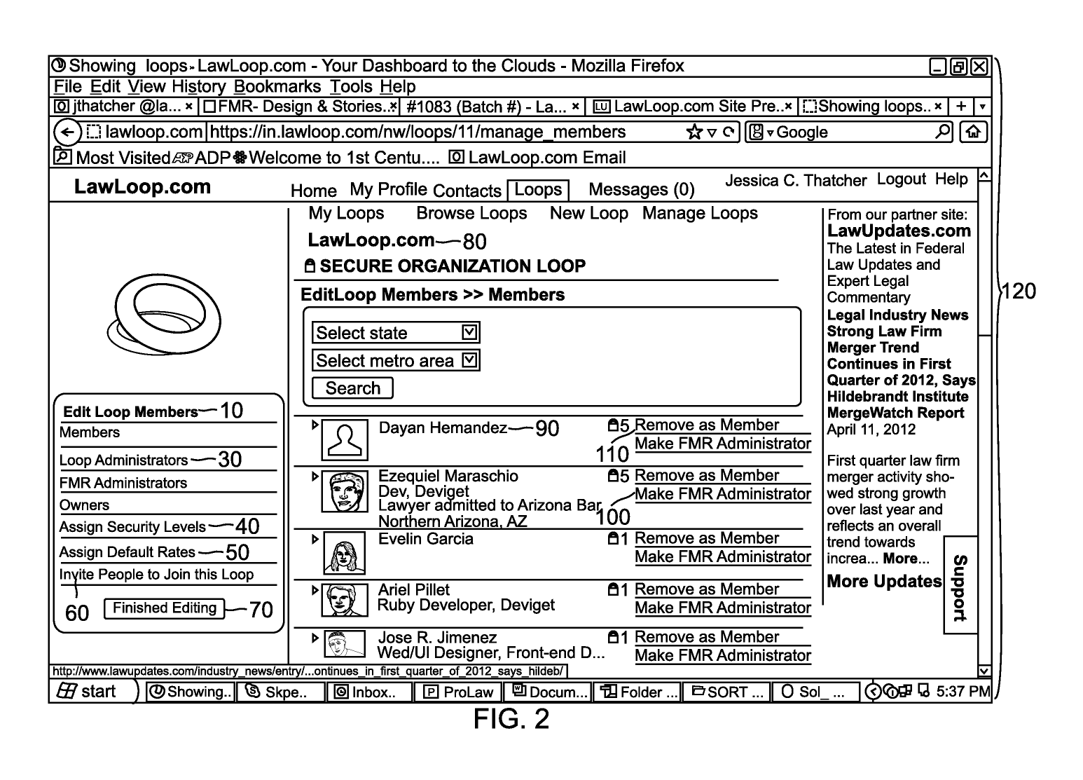

Once the user has clicked on Edit Loop Members (as shown at 10 in FIG. 1) the user will reach the Edit Loop Members page (as shown at 120 in FIG. 2). Via the Edit Loop Members page the user may choose to invite any number of contacts to become new members of the SOL (as shown at 60 in FIG. 2) or to remove existing members (as shown at 110 in FIG. 2). If the user were to invite contacts to join the LawLoop.com SOL (as shown at 80 in FIG. 2) contacts that accept the invitation to join, invitees, would only be granted access to the individual LawLoop.com SOL. Membership to one SOL does not grant access to all the Loops that may exist in the inviting member's account. Likewise, if an existing LawLoop.com SOL member, such as Dayan Hernandez (as shown at 90 in FIG. 2), is removed from the SOL by clicking on the Remove as Member link (as shown at 110 in FIG. 2) then that newly designated ex-member only loses access to the individual SOL in question (as shown at 80 in FIG. 2). Whatever the membership status or statuses of the ex-member in regard to other SOLs may be, it or they remain unaffected. The actions to Invite People to Join this Loop (as shown at 60 in FIG. 2) or to Remove as Member (as shown at 110 in FIG. 2) affect only the individual SOL, (as shown at 80 in FIG. 2).

The Edit Loop Members page also affords the user a wide array of options, in regard to what members of the SOL can access and what happens when they do. All the Edit Loop Members settings (as pictured at 10 on FIG. 2) affect only and specifically the SOL in question, (as shown at 80 in FIG. 2), as does the Remove as Member option (as shown at 110 in FIG. 2) and the Make FMR Administrator option (as shown at 100 in FIG. 2). The user may define settings for individual members, such as granting Loop administrator level control and access (as shown at 30 in FIG. 2). The user may wish to assign specific security levels (as shown at 40 in FIG. 2) to one or more members. Different security levels determine what content any given member may access, read, and or save to the SOL. The user may also wish to Assign Default Rates for billing purposes (as shown at 50 in FIG. 2) to a member. When the user is finished editing member settings the user clicks the Finished Editing button (as shown at 70 in FIG. 2) to save the changes made.

### Show and Hide Matters

The term “Matter” is defined as it is commonly understood in the legal industry, a specific job being worked on for a client such as a lawsuit or a business deal, for example a litigation matter, or a transactional matter.

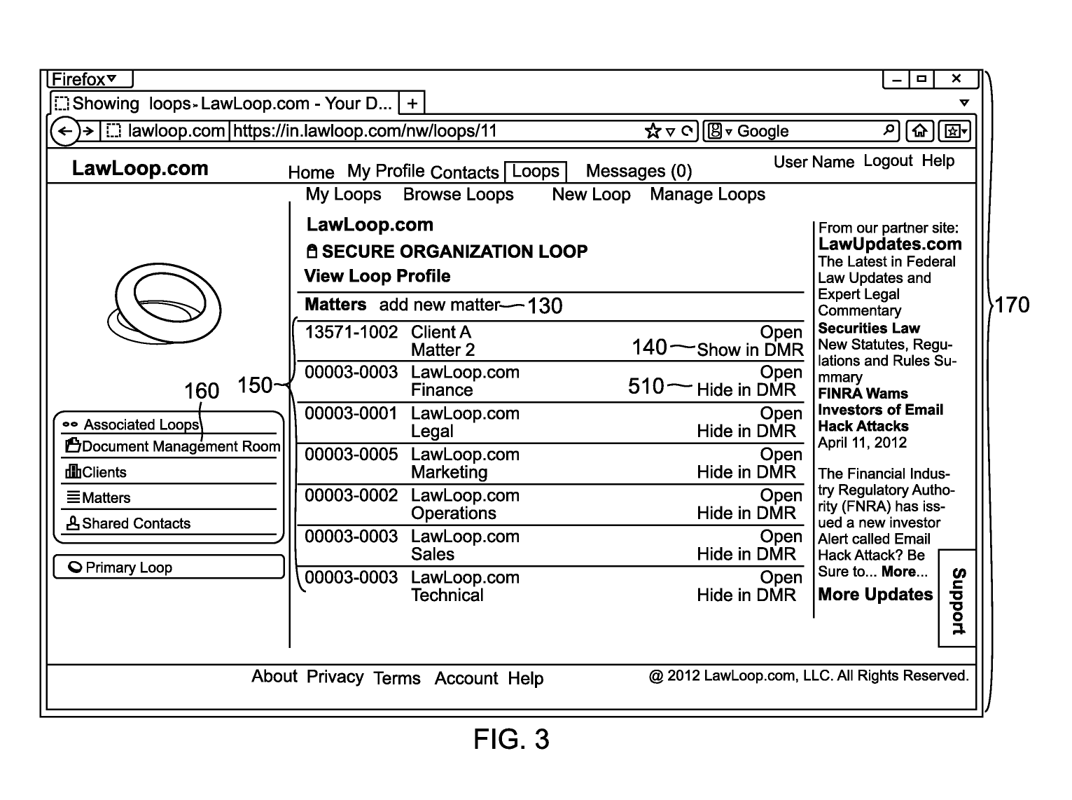

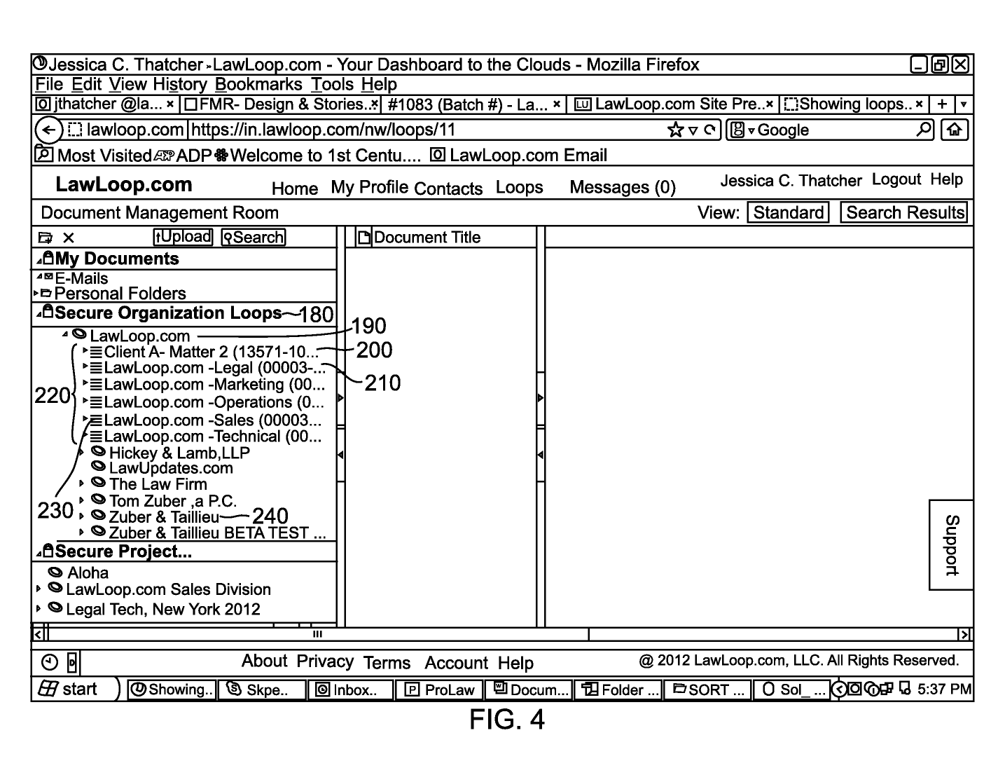

Once an invited contact accepts their invitation to join a SOL and becomes a member, the new member can determine what content, in this case which Matters (as shown at 150 in FIG. 3) they would like to view and have access to in the DMR (as shown at 220 in FIG. 4). All members of a SOL can pick and choose which Matters to show or hide in the DMR via the View Loop Profile Page (as shown at 170 in FIG. 3). Members may not need to access all the Matters that exist in the SOL (as shown at 150 in FIG. 3). Instead a SOL's member may only wish to list Matters in the DMR (as shown at 220 in FIG. 4) that they have some responsibility for, want to monitor or have some expressed interest in. When a member first joins a SOL, all the SOLs Matters are initially hidden from the new member. The new member must decide which SOL Matters to list in the DMR. In order to view a full listing of all existing Matters in a SOL (as shown at 150 in FIG. 3) and to further determine which Matters a member would like to view and have access to in the DMR, the member must click on the Matters link found in the SOL Profile page (as shown at 20 in FIG. 1). At the View Loop Profile page (as shown at 170 in FIG. 3) the member may initiate the creation of a new Matter within the SOL by clicking on the Add New Matter link (as shown at 130 in FIG. 3), and determining its unique settings and features. The member may also choose to click an existing Matter's Show in DMR link (as shown at 140 in FIG. 3) to allow a Matter to be shown in their DMR and have its contents be accessible (as shown at 200 in FIG. 4). Clicking on a Matter's Show in DMR link turns that link into a Hide in DMR link (as shown at 140 in FIG. 3) to indicate to the member that the Matter in question has been listed and is accessible in the DMR (as shown at 210 in FIG. 4). After clicking Show in DMR (as shown at 140 in FIG. 3) on one or more Matters would list those Matters in the DMR (as shown at 220 in FIG. 4) which would be accessible to the member provided the respective member(s) have the appropriate administrative rights to do so. Administrative rights include security levels which determine a member's security clearance. The creator or an administrator of a Matter may have assigned a certain security level to specific members, for which if the minimum security clearance is not met access to the Matter or certain content within the Matter is denied. The member may also wish to hide a Matter in a SOL whose content is currently listed and accessible in the DMR (as shown at 200 in FIG. 4) by clicking on its Hide in DMR link in the View Loop Profiles page (as shown at 140 in FIG. 3). When a Matter has been hidden by clicking the Hide in DMR link (as shown at 140 in FIG. 3) the Hide in DMR link turns into a Show in DMR link to indicate to the member that the Matter has been hidden and is no longer listed in the DMR.

### The Document Management Room

Once a member has determined which Matter(s) will be listed and accessible in the DMR by clicking on its or their respective Show in DMR link(s) in the View Loop Profile page (as shown at 170 in FIG. 3), the user can click through to the DMR (as shown at 160 in FIG. 3). Matters are designated by their icon, which consists of four horizontal lines that appear as if they were lines of text (as shown at 230 in FIG. 4). The DMR page provides a SOL section (as shown at 180 in FIG. 4) that lists all of the existing SOLs in the user's account to which the user belongs as a member. A SOL is a type of network called a loop and loops are designated by their icon, a purple loop (as shown at 240 in FIG. 4). Within each SOL any number of Matters may exist, as any number of Matters may be created by members and administrators. Only the Matters that have been designated to be shown in the DMR in the View Loop Profiles page are listed and accessible to a member in the DMR (as shown at 220 in FIG. 4). Matters are listed in the DMR as subitems (as shown at 220 in FIG. 4) of their respective SOL (as shown at 190 in FIG. 4). If no Matters have been selected to be shown within a SOL in the DMR the SOL is still listed in the DMR. However, no arrow pointer appears next to a SOL in order to indicate that no Matter are present within that SOL (as shown at 240 in FIG. 4). In both the View Loop Profiles page (as shown at 150 in FIG. 3) and in the DMR (as shown at 220 in FIG. 4) Matters are listed in alphabetical order, but can also be listed by ascending or descending client-matter number, or a number of other ordering means well known in the art. Each Matter is associated with a folder set and subfolder set, which folder sets and subfolder sets are created and determined by the SOL's network administrator(s) and/or the SOL members.

### The Document Management Room, Expanded View

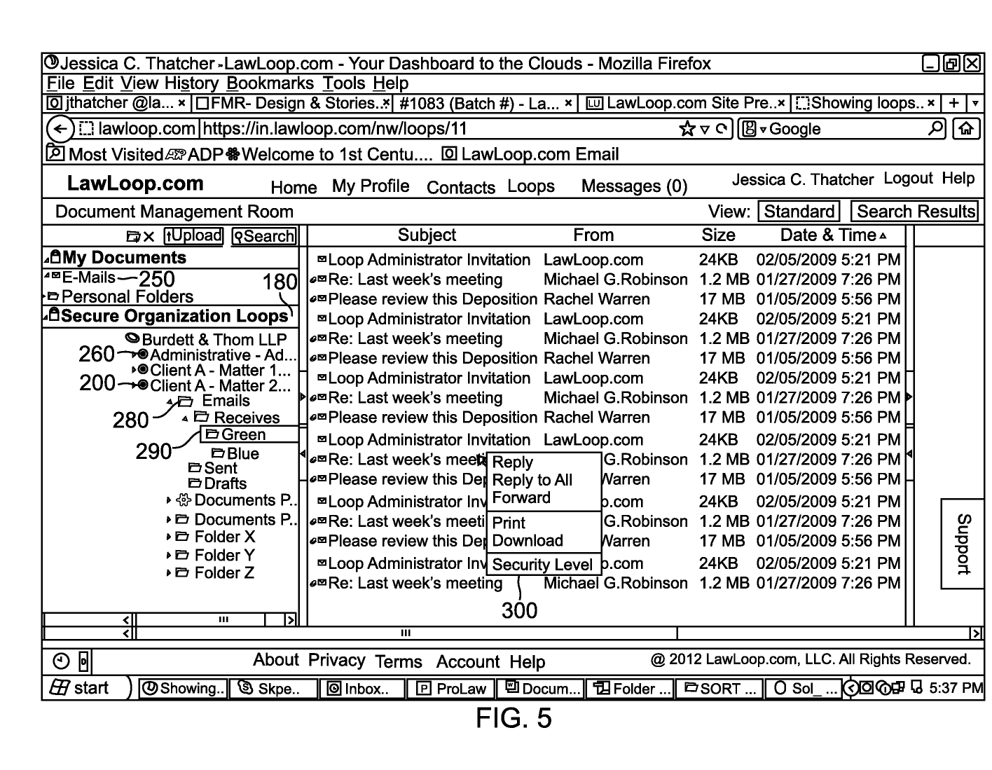

A SOL (as shown at 180 in FIG. 5) expands to show a unique folder tree that further displays a fully customizable folder set which the user can use to organize their documents and emails on a per Matter basis.

In the preferred embodiment, at least basic email folders for each Matter—for instance, a Received folder, a Sent folder and a Drafts folder, are system folders. A system folder is a type of folder that is automatically created and associated with each Matter and cannot be altered, deleted or otherwise moved. System folders within SOLs are designated as purple icons (as shown at 250 and 280 in FIG. 5). The personal emails folder itself is also a system folder (as shown at 250 in FIG. 5). Users also have email system folders available to them at the Matter level (as shown at 280 in FIG. 5), which when email functionality is accessed becomes a Folder Conduit (as shown at 200 in FIG. 5).

When the user is accessing email in the DMR, Matter icons (as shown at 230 in FIG. 4) are replaced by Folder Conduit icons (as shown at 200 in FIG. 5) in order to indicate to the user the change to functional email capabilities. Because the user has selected and highlighted an email alias folder (as shown at 290 in FIG. 5) Matter icons change into Folder Conduit icons, as would be the case whenever a user accesses an email or email folder in the DMR. Instead of the four horizontal line Matter icon (as seen at 230 in FIG. 4) the Folder Conduit icon appears (as shown at 200 in FIG. 5) which looks like a solid circle within the outline of another circle.

Email functionality in the DMR also includes the ability to right-click on (or otherwise select) an email to reply, reply to all, forward, print, download and set a security level for an email (as shown at 300 in FIG. 5).

Email system folders asssociated with Folder Conduits are then the first available folders, listed at the top of a Folder Conduit's folder tree (as shown at 280 in FIG. 5). Email system folders are found in all Folder Conduits and include the following folder tree, where the Email folder is the parent folder (as shown at 280 in FIG. 5), Received, Sent and Drafts folders. SOL members may create a number of alias email folders in email system folders which can be edited at will (as shown at 290 in FIG. 5). Alias email folders are not system email folders. Alias email folders can be created, deleted, renamed and moved by the member or members of the SOL. Alias folders are associated with their respective parent system email folders. Alias email folders are shared and can be accessed and their contents viewed by other members of the SOL.

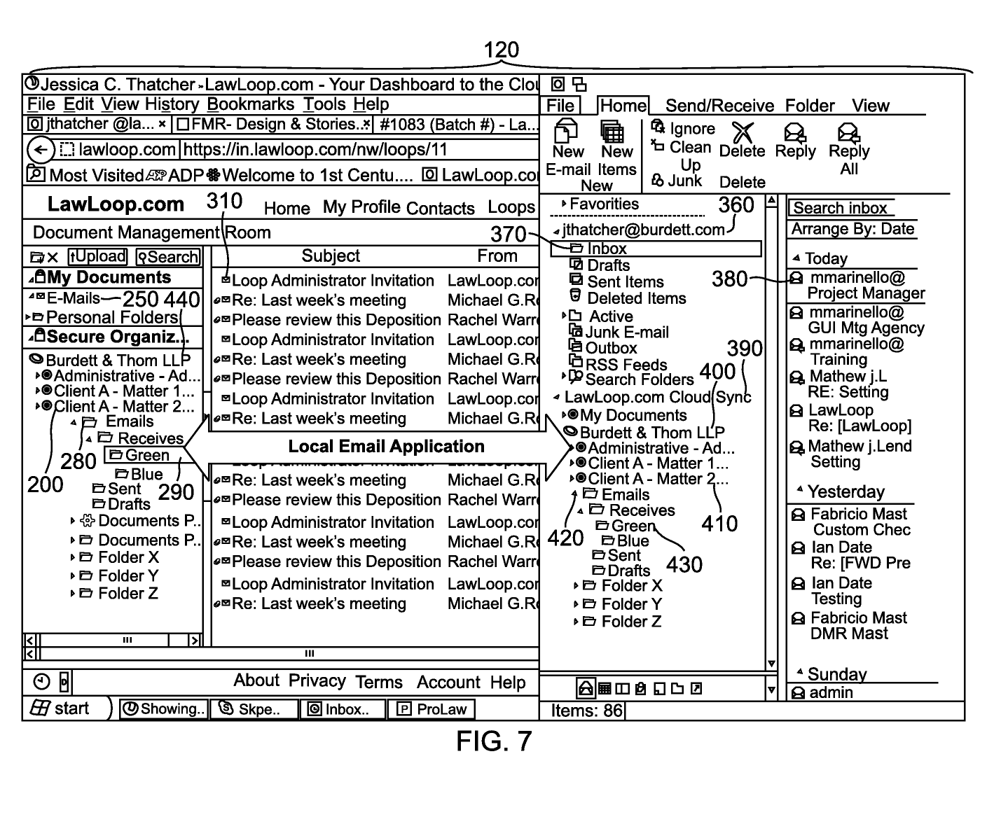

The member can keep email they do not want to share with any other member in a private email folder (as shown at 250 in FIG. 5). It is important to note that the email account used within the SOL corresponds to the member's profile. In the preferred embodiment of the DMR, the personal email folder (as shown at 250 in FIG. 7) is the user's local email application email (as shown at 370 in FIG. 7). The user's personal email folder includes but is not limited to Inbox, Drafts, Sent Items, Deleted Items folders.

Only email(s) and their attachments may exist in email folders, both in personal email folders (as shown at 250 in FIG. 5) or in Folder Conduit system email folders (as shown at 280 in FIG. 5) and alias email folders (as shown at 290 respectively in FIG. 5). By putting, or “dragging and dropping” an email in at least one or more of the Folder Conduit's email folders (as shown at 280 in FIG. 5) that email becomes associated with that particular Matter. The same email can also be associated with any number of SOLs, Matters and their respective email folders.

### The Folder Conduit Process

FIG. 5 shows a DMR with emails listed (i.e.: with columns Subject, From, Size, Date & Time) in the largest subwindow, and folders of a folder set associated with a Matter “Client A—Matter 2 . . . ” (shown at 200 in FIG. 5). FIG. 7 shows the left half of the screen of a local email application, well-known in the art, superimposed over the left portion of the DMR shown in FIG. 7.

A Folder Conduit is an item (as shown at 200 in FIG. 5), associated with a Matter, typically but not necessarily in the form of a header for that Matter, typically but not necessarily containing an identification means for that Matter (e.g.: the name of the client with whom the Matter is associated plus the name of the Matter), that serves as a shortcut for filing an email within a particular folder of a folder set associated with the Matter with which the Folder Conduit is associated. A Folder Conduit serves as the link between the DMR and the local email application. Each Folder Conduit has its own unique corresponding email folder and subfolder tree because the user may want to associate and easily archive a particular email or emails and attachments with a specific Matter. By moving an email into a Folder Conduit email folder, the user shares that email and, if present, its attachments with other members of the SOL. Other SOL members may also share and pool emails related to the Matter with this method. In the preferred embodiment email in the DMR is handled entirely by the local email application. The Folder Conduit tracks the associations that are created by the user, between email and Matters, when the user “drags and drops” an email or a number of emails into a Folder Conduit, email system folder or alias email folder.

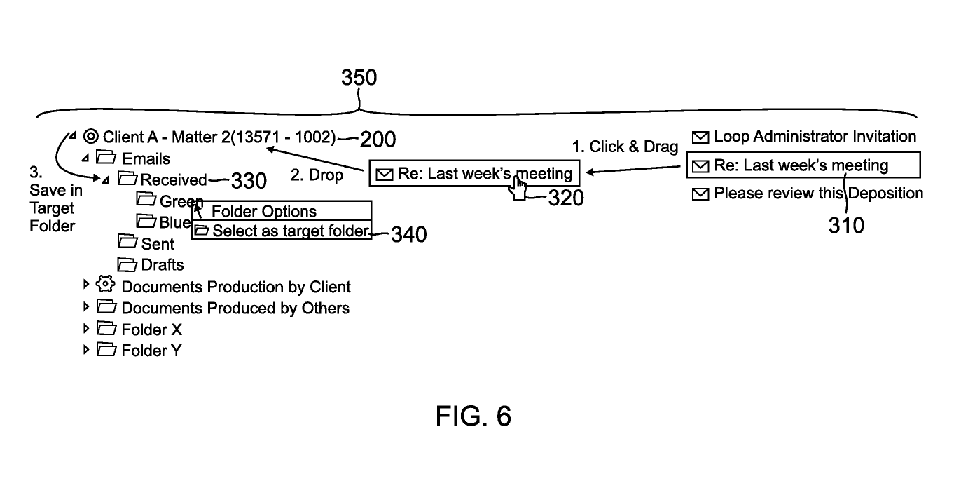

The process by which a user can accomplish associating an email with a Matter is as simple as a “drag and drop” action (as shown at 350 in FIG. 6). In order to associate an email with a Matter, the user must first decide which email will be moved from its original location (as shown at 310 in FIG. 6). The chosen email is then clicked on and held with the cursor as it is dragged (as shown at 320 in FIG. 6) directly over Matter's corresponding Folder Conduit. Second the user drops the selected email on the Folder Conduit (as seen at 200 in FIG. 6). The email that is dropped on the Folder Conduit is automatically sent to a predetermined, user designated, target folder (as shown at 330 in FIG. 6). The user selects a target email folder by right-clicking on the desired email subfolder and selecting the “Select as target folder” option (as shown at 340 in FIG. 6). In this manner the Folder Conduit need not even be in expanded form (as shown at 200 in FIG. 6), where the whole folder tree is visible below the Folder Conduit, in order for the user to “drop” an email into the correct email folder. The user may also “drag and drop” an email or a group of emails directly into a desired email folder by dropping said email directly over the intended and listed email folder. The feature to “drag and drop” an email into a Folder Conduit, which sends the email to the designated target email folder and to “drag and drop” an email into a specific email folder within a Folder Conduit exists in both the DMR in LawLoop.com and also in the version of the DMR which has been integrated into the local email application because the Folder Conduit feature facilitates that action and the associations created between an email and their designated email folders.

### The Document Management Room and the Local Email Application

LawLoop.com's DMR email and the local email application's email systems are one and same (as shown at 450 in FIG. 7). Whatever email related action occurs, it occurs in the LawLoop.com's DMR because the local email application is the email engine. The local email application has been fully integrated into LawLoop.com's DMR to handle all things email related. LawLoop.com's DMR is likewise designed to function in the local email application, in order for emails to be able to be associated with Matters within the local email application. If a user wishes to take advantage of using the DMR entirely in the local email application they may do so.

An email can be associated with Matter, and filed in a folder associated with that Matter, by dragging and dropping the email onto a Folder Conduit associated with the Matter (as shown at 350 in FIG. 6). In effect whatever a user does in one program in regard to associating emails to Matters, be it either in the DMR or the local email application, that action is executed in the other program. For example, if a user in the local email application “drags and drops” an email (as shown at 380 in FIG. 7) from their local email application Inbox (as shown at 370 in FIG. 7) onto a (as shown at 400 in FIG. 7) Folder Conduit (as shown at 410 in FIG. 7) that email will appear in the member's pre-determined target folder, (as shown at 430 in FIG. 7). In the preferred embodiment, the target folder is pre-determined automatically. For example, as shown in FIG. 7, an email 380 in the Inbox folder 370 of the local email application, when clicked and dragged over the Folder Conduit 410 for a Matter, will automatically be filed in the “Green” system folder 430 associated with that Matter, whether of not the Green system folder 430 is visible at the time the email is dragged (i.e.: as it would not be visible if the folder set associated with that Matter 410 is collapsed). The local email application will sync with the cloud-based DMR automatically, without further action by the user, such that the email also appears in the “Green” system folder 290 associated with that Matter 200 as displayed in the DMR, such that other members of the network could view and access the email in the Green system folder 290 as displayed in the own DMR viewed via their own accounts. Similarly, an email starting in the Sent folder of the local email application would via an analogous dragging and dropping process be filed in the Sent folder associated with the folder set at 410 and the folder set at 200, and an email starting in the Drafts folder of the local email application would via an analogous dragging and dropping process be filed in the Drafts folder associated with the folder set at 410 and the folder set at 200. In an alternative embodiment, the user can pre-determine which folder shall be the target folder beforehand by right-clicking on the target folder. Meanwhile in the DMR that same email will also appear in the corresponding pre-determined target folder (as shown at 290 in FIG. 7) within the corresponding Folder Conduit (as shown at 200 in FIG. 7) of the same SOL (as seen at 440 in FIG. 7). The DMR email alias folder (as shown at 290 in FIG. 7) is identical in both contents and placement within the email folder tree as its counterpart is in the local email application (as shown at 430 in FIG. 7). The DMR email folder tree (as shown at 280 in FIG. 7) is also associated with and is found within the same Folder Conduit (as shown at 200 in FIG. 7) as it was in the local email application (as shown at 410 in FIG. 7) which in turn is associated with and is found within the same SOL (shown at 440 in FIG. 7) as it was in the local email application (as shown at 400 in FIG. 7). Emails themselves and their attachments, if any exist, can be accessed and viewed in the DMR (as shown at 310 in FIG. 7). If the user moves an email between existing Folder Conduit email folders, either within the DMR or the local email application, the action would be mirrored in the opposite program, regardless of whether the user initiates the action of moving an email from within either the DMR in LawLoop.com or executed DMR in the local email application and regardless of whether the user is logged into the other program or not as email data is handled by the local email application and the associations of emails to Matters are facilitated by the Folder Conduits.

As within the DMR, only emails may exist in email folders and subfolders (as shown at 420 in FIG. 7) that are found within Folder Conduits (as shown at 130 in FIG. 7) in the local email application (as shown at 390 in FIG. 7). Also like in the DMR, the user may move one email or more into multiple Folder Conduits and email folders in the local email application. Likewise the user may move an email into email folders found in different Matters and SOLs as an email may relate to any number of Matters and networks. If an email is moved from one email folder into another, or if an email is moved into multiple email folders, the email appears and is accessible within the designated email folders but still remains in the original email folder as well. The local email application doesn't create individual copies of an email that then live within various email folders so much as the Folder Conduit Process (as shown at 350 in FIG. 6) creates new associations between an email and any number of Matters and their email folders. In this manner the user can access the email, and if they are present its attachments, in any email folder they moved the email into because the local email application archives the email while the Folder Conduit feature archives the associations of an email to any number of Matters and SOLs.

Unlike within the DMR, Matter icons (as shown at 230 in FIG. 4) will not exist in the local email application (as shown at 390 in FIG. 7) as Matters will always be represented by Folder Conduit icons (as shown at 410 in FIG. 7) to always indicate email functionality within the local email application to the user.

Digital content that can be handled and shared by LawLoop.com's DMR email feature includes but is not limited to emails and attachments like various types of documents, (Word and PDFs) and also includes but is not limited to image file types, (JPGs, GIFs, PNGs, TIFFs and BMPs) and any other type of digital file.

Now described as follows is an alternative embodiment of the file conduit feature

### The Document Management Room, Expanded View, Alternative Embodiment

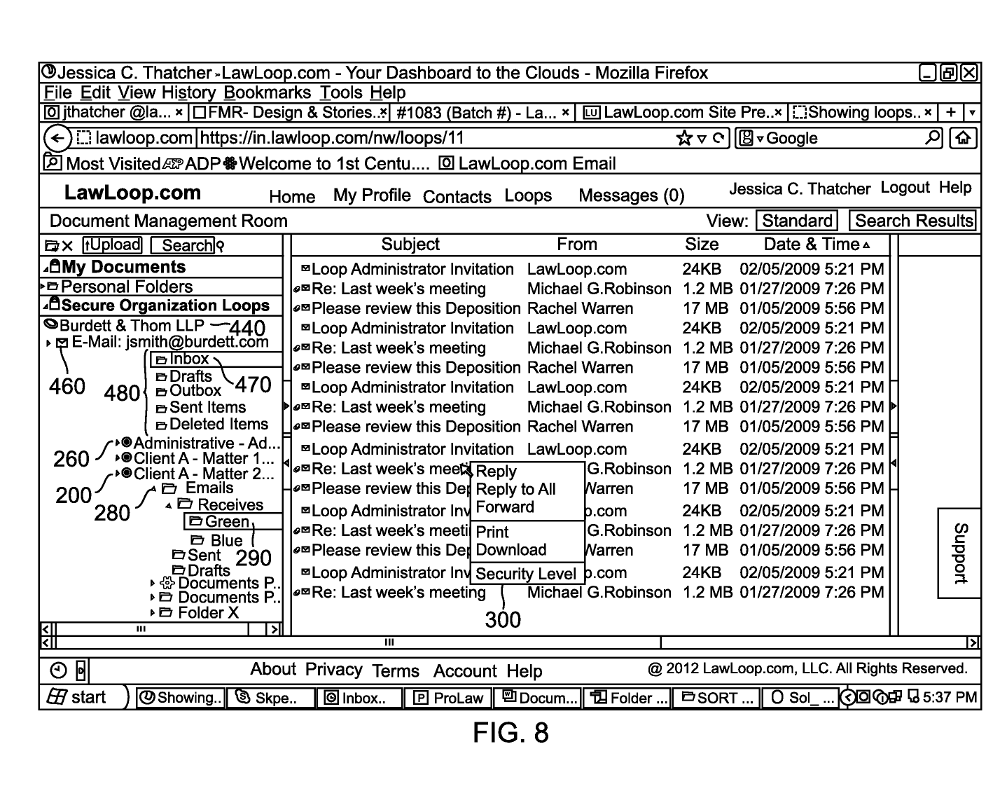

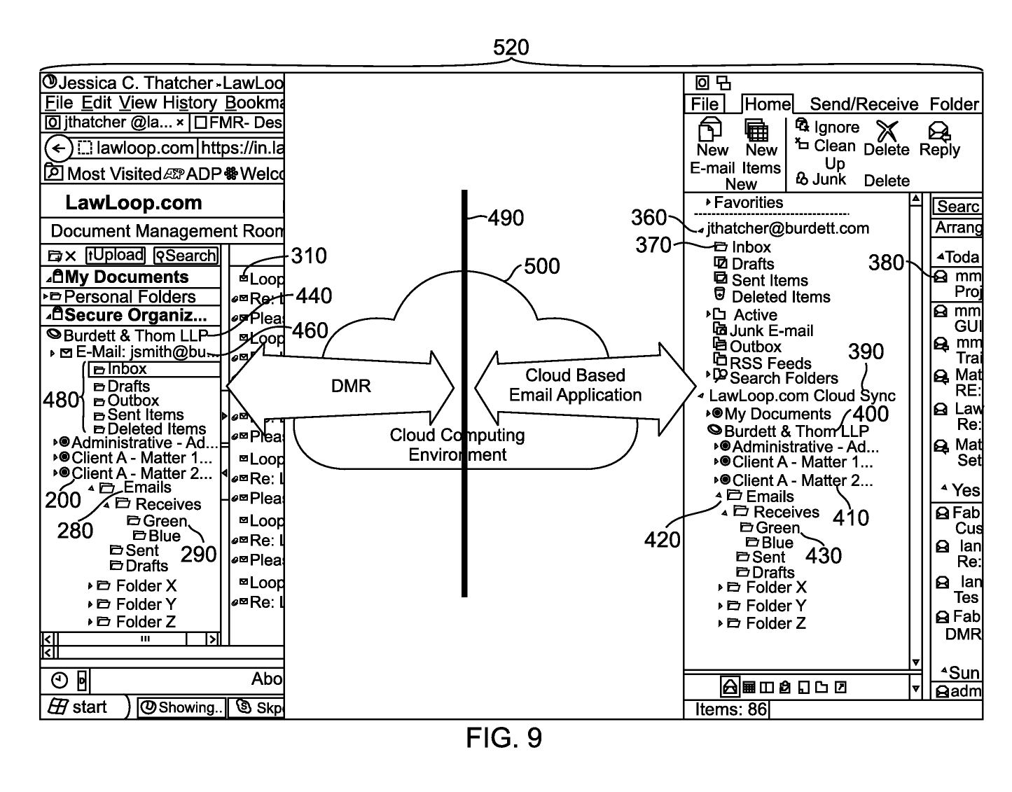

The first available folder, listed at the top of a SOL's folder tree, is the member's personal email folder (as shown at 460 in FIG. 8). It is important to note that the email account used within the SOL corresponds to the member's profile. All the email corresponding to the member's email address (as shown at 460 in FIG. 8) is available in its respective email folders (as shown at 480 in FIG. 8). For example, if an email in the cloud based email application is found in the member's Inbox (as shown at 370 in FIG. 9) that same email is then also found in the member's Inbox in the DMR (as shown at 470 in FIG. 8). All emails found in the member's Inbox, Drafts, Outbox, Sent Items, and Deleted Items folders are synchronized between the DMR and the cloud based email application.

Folder Conduits appear below the user's email folders within a SOL (as shown at 260 in FIG. 8). Email system folders in Folder Conduits are then the first available folders, listed at the top of a Folder Conduit's folder tree (as shown at 280 in FIG. 8).

### The Folder Conduit Process

In the alternative embodiment emails in the DMR are handled by the cloud based email application.

The feature to “drag and drop” an email into a Folder Conduit, which sends the email to the designated target email folder and to “drag and drop” an email into a specific email folder within a Folder Conduit exists in both the DMR in LawLoop.com and also in the DMR which has been integrated into the cloud based email application because the Folder Conduit feature facilitates that action and the associations created between an email and their designated email folders.

### The Document Management Room and the Cloud-Based Email Application

LawLoop.com's DMR email and the cloud based email application's email are mirrors of each other where email data is synchronized between both programs (as shown at 520 in FIG. 9). This is possible because of the Folder Conduit (as shown at 200 in FIG. 9). Folder Conduits are virtual place holders that exist in a cloud computing environment (as shown at 500 in FIG. 9). A Folder Conduit serves as the link between the DMR and the cloud based email application. The virtual “minor” that a cloud based email application facilitates is represented by a line running down the middle of the cloud (as shown at 490 in FIG. 9). In effect whatever a user does in one program in regard to emails, be it either in the DMR or the cloud based email application, that action is synchronized or mirrored in the other program. For example, if a user in the cloud based email application “drags and drops” an email (as shown at 380 in FIG. 9) from their cloud based email application Inbox (as shown at 370 in FIG. 9) into a SOL's (as shown at 400 in FIG. 9) Folder Conduit (as shown at 410 in FIG. 9) that email will appear in the member determined target email folder, (as shown at 430 in FIG. 9). Meanwhile in the DMR that same email will also appear in the same target email folder (as shown at 290 in FIG. 9) within the same Folder Conduit (as shown at 200 in FIG. 9) of the same SOL (as seen at 440 in FIG. 9). The mirrored folder (as shown at 290 in FIG. 9) is identical in both contents and placement within the email folder tree as its counterpart is in the cloud based email application (as shown at 430 in FIG. 9). The DMR email folder tree (as shown at 280 in FIG. 9) is also associated with and is found within the same Folder Conduit (as shown at 200 in FIG. 9) as it was in the cloud based email application (as shown at 410 in FIG. 9) which in turn is associated with and is found within the same SOL (shown at 440 in FIG. 9) as it was in the cloud based email application (as shown at 400 in FIG. 9). If the user moves an email between existing Folder Conduit email folders, either within the DMR or the cloud based email application, the action would be mirrored in the opposite program, regardless of whether the user initiates the action of moving an email from within either the DMR or the cloud based email application and regardless of whether the user is logged into the other program or not as email data lives in the cloud computing environment.

The cloud based computing application environment (as shown at 500 in FIG. 9) also facilitates the minoring of not just Folder Conduits but also of the user's personal email (as shown at 360 in FIG. 9) on the DMR (as shown at 460 in FIG. 9). The user's personal email account folders, including their Inbox, Drafts, Sent Items and Deleted Items folders are mirrored in the DMR (as shown at 480 in FIG. 9). These personal email folders are system folders within the DMR. The emails found within the user's personal email folders in the DMR (as shown at 480 in FIG. 9) appear in the same folders as they would in the cloud based email application and behave as if the user were accessing their email through their cloud based email application. Emails themselves and their attachments, if any exist, are listed and can be accessed in the DMR (as shown at 310 in FIG. 9).

As within the DMR, only emails may exist in email system folders and alias subfolders (as shown at 420 in FIG. 9) that are found within Folder Conduits (as shown at 410 in FIG. 9) in the cloud based email application (as shown at 390 in FIG. 9). Also like in the DMR, the user may move one email or more into multiple Folder Conduits and email folders in the cloud based email application. Likewise the user may move an email into email folders found in different Matters and SOLs as an email may relate to any number of Matters. If an email is moved from one email folder into another, or if an email is moved into multiple email folders, the email appears and is accessible within the designated email folders but still remains in the original email folder as well. The cloud based email application doesn't create individual copies of an email that then live within various email folders so much as it creates new associations with different Folder Conduits and their email folders. In this manner the user can access the email, and if they are present its attachments, in any email folder they moved the email into because the cloud based email application archives the email while the Folder Conduit feature archives the associations of an email to any number of Matters and SOLs.

Unlike within the DMR, Matter icons (as shown at 230 in FIG. 4) will not exist in the cloud based email application (as shown at 390 in FIG. 9) as Matters will always be represented by Folder Conduit icons (as shown at 410 in FIG. 9) to always indicate email functionality within the cloud based email application to the user.

Although the foregoing description is directed to the preferred embodiments of the invention, other variations and modifications may be made without departing from the spirit or scope of the invention. Moreover, features described in connection with one embodiment of the invention may be used in conjunction with other embodiments, even if not explicitly stated above.

What is claimed is:

1) A method for interactively collaborating within an online community, comprising:
a plurality of members;
a network of members that excludes at least one member of the community, whereby members of the network share access to financial information in a secured remote environment, such that members not belonging to the network do not have access to the financial information;
a financial management tool comprised of a billing application and an invoicing application, whereby the financial management tool enables the members of the network to remotely manage the financial information;
a matters tool for assigning a folder set to a matter, whereby a member of the network can cause the folder set to appear in the user's document management room, whereby the folder set also appears in the user's local email application; and
a folder conduit associated with the folder set, whereby a member of the network can drag and drop an email over the folder conduit and thereby cause the email to appear in pre-designated folder of the folder set in the user's email application.

2) The method of claim 1, whereby the email also appears in the folder set of the user's document management room.

3) A method for interactively collaborating within an online community, comprising:
a plurality of members;
a network of members that excludes at least one member of the community, whereby members of the network share access to financial information in a secured remote environment, such that members not belonging to the network do not have access to the financial information;
a financial management tool comprised of a billing application and an invoicing application, whereby the financial management tool enables the members of the network to remotely manage the financial information;
a matters tool for assigning a folder set to a matter, whereby the folder set appears in the user's local email application; and
a folder conduit associated with the folder set, whereby a member of the network can drag and drop an email over the folder conduit and thereby cause the email to appear in pre-designated folder of the folder set in the user's email application.

4) The method of claim 3, whereby the folder set also appears in the user's document management room, and the email also appears in the folder set of the user's document management room.
